(19) United States
(12) Patent Application Publication
(10) Pub. No.: US 2016/0180995 A1
(43) Pub. Date: Jun. 23, 2016

(54) ELECTRONIC COMPONENT AND METHOD FOR MANUFACTURING THE SAME

(71) Applicant: SAMSUNG ELECTRO-MECHANICS CO., LTD., Suwon-Si (KR)

(72) Inventors: Jeong Hyun PARK, Suwon-Si (KR); Ki Hyun PARK, Suwon-Si (KR)

(21) Appl. No.: 14/886,846

(22) Filed: Oct. 19, 2015

(30) Foreign Application Priority Data
Dec. 23, 2014 (KR) 10-2014-0187398

(51) Int. Cl. H01F 3/08; H01F 41/02

(52) U.S. Cl. CPC H01F 3/08; H01F 41/0246

(57) ABSTRACT

There are provided an electronic component and a method for manufacturing the same. The electronic component may include: a magnetic body containing magnetic metal powder; and internal coil parts embedded in the magnetic body, wherein the magnetic body includes a first magnetic part and a second magnetic part distinguished from the first magnetic part.

### CROSS-REFERENCE TO RELATED APPLICATION

This application claims the priority and benefit of Korean Patent Application No. 10-2014-0187398 filed on Dec. 23, 2014, with the Korean Intellectual Property Office, the disclosure of which is incorporated herein by reference.

### BACKGROUND

The present disclosure relates to an electronic component and a method for manufacturing the same.

An inductor, an electronic component, is a representative passive element configuring an electronic circuit together with a resistor and a capacitor to remove noise.

A thin film type inductor is manufactured by forming internal coil parts by plating, hardening a magnetic powder-resin composite in which a magnetic powder and a resin are mixed with each other to manufacture a magnetic body, and forming external electrodes on outer surfaces of the magnetic body.

### SUMMARY

An exemplary embodiment in the present disclosure may provide an electronic component having excellent quality factor (QF) and direct current (DC)-bias characteristics (change characteristics in inductance depending on application of current), and a method for manufacturing the same.

According to an exemplary embodiment in the present disclosure, an electronic component may include: a magnetic body containing magnetic metal powder; and internal coil parts embedded in the magnetic body, wherein the magnetic body includes a first magnetic part and a second magnetic part distinguished from the first magnetic part.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of an electronic component including internal coil parts according to an exemplary embodiment in the present disclosure;

FIG. 2 is a cross-sectional view taken along line I-I′ of FIG. 1;

FIG. 3 is a cross-sectional view of an electronic component according to another exemplary embodiment in the present disclosure in an LT direction;

FIG. 4 is a cross-sectional view of an electronic component according to another exemplary embodiment in the present disclosure in an LT direction;

FIG. 5 is a cross-sectional view of an electronic component in which first and second magnetic parts contain two kinds of magnetic metal powder having different particle sizes and being mixed with each other at a predetermined ratio, according to another exemplary embodiment in the present disclosure;

FIG. 6 is a view of the formation of the internal coil parts of the electronic component according to an exemplary embodiment in the present disclosure;

FIGS. 7A and 7B are views of the formation of a magnetic body of the electronic component according to an exemplary embodiment in the present disclosure;

FIGS. 8A and 8B are views of the formation of a magnetic body of the electronic component according to another exemplary embodiment in the present disclosure; and

FIGS. 9A and 9B are views of the formation of a magnetic body of the electronic component according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

### Electronic Component

Hereinafter, an electronic component according to exemplary embodiments, particularly, a thin film type inductor, will be described. However, the electronic component, according to the present inventive concept, is not limited thereto.

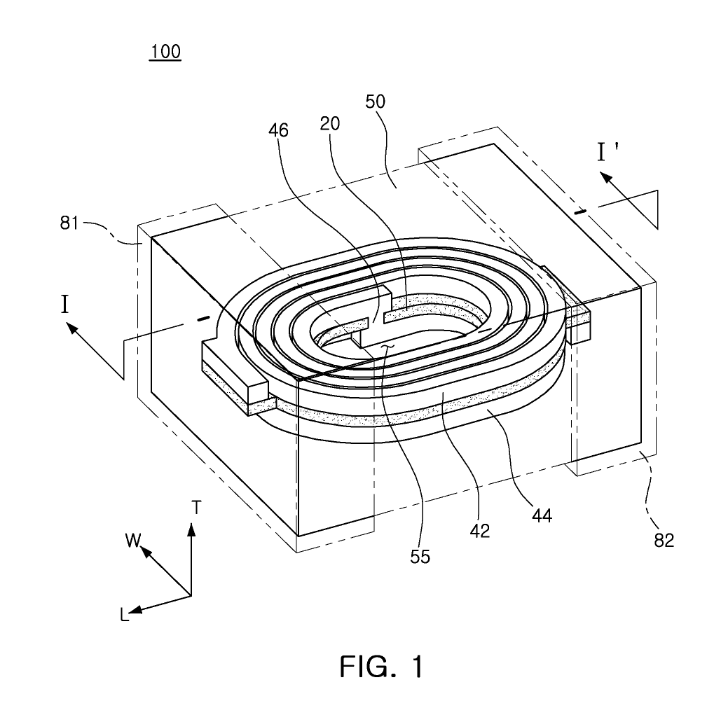

FIG. 1 is a schematic perspective view illustrating an electronic component including internal coil parts according to an exemplary embodiment.

Referring to FIG. 1, a thin film type inductor used in a power line of a power supply circuit is illustrated as an example of the electronic component.

An electronic component 100, according to an exemplary embodiment, may include a magnetic body 50, internal coil parts 42 and 44 embedded in the magnetic body 50, and first and second external electrodes 81 and 82 disposed on outer surfaces of the magnetic body 50 and connected to the internal coil parts 42 and 44.

In the electronic component 100, according to an exemplary embodiment, a “length” direction refers to an “L” direction of FIG. 1, a “width” direction refers to a “W” direction of FIG. 1, and a “thickness” direction refers to a “T” direction of FIG. 1.

The magnetic body 50 may form an outer casing of the thin film type inductor 100 and may be formed of any material that exhibits magnetic properties. For example, the magnetic body 50 may contain magnetic metal powder.

The magnetic metal powder may be formed of a crystalline or amorphous metal containing one or more selected from the group consisting of iron (Fe), silicon (Si), chromium (Cr), copper (Cu), aluminum (Al), molybdenum (Mo), or nickel (Ni).

The magnetic metal powder may be dispersed in a thermosetting resin such as epoxy or polyimide.

A first internal coil part 42 may be formed on one surface of an insulating substrate 20 disposed in the magnetic body 50, and a second internal coil part 44 may be formed on the other surface of the insulating surface 20 opposing one surface of the insulating substrate 20.

The first and second internal coil parts 42 and 44 may be formed by electroplating.

The insulating substrate 20 may be, for example, a polypropylene glycol (PPG) substrate, a ferrite substrate, a metal based soft magnetic substrate, or the like.

The insulating substrate 20 may have a through-hole formed in a central portion thereof to penetrate through the central portion thereof, wherein the through-hole may be filled with a magnetic material to form a core part 55. The core part 55 may be filled with the magnetic material, thereby improving inductance (Ls).

The first and second internal coil parts 42 and 44 may have a spiral shape, and the first and second internal coil parts 42 and 44 formed on one surface and the other surface of the insulating substrate 20, respectively, may be electrically connected to each other through a via 46 penetrating through the insulating substrate 20.

The first and second internal coil parts 42 and 44 and the via 46 may be formed of a metal having excellent electrical conductivity, such as silver (Ag), palladium (Pd), aluminum (Al), nickel (Ni), titanium (Ti), gold (Au), copper (Cu), platinum (Pt), or an alloy thereof.

One end portion of the first internal coil part 42 formed on one surface of the insulating substrate 20 may be exposed to one end surface of the magnetic body 50 in the length (L) direction thereof, and one end portion of the second internal coil part 44 formed on the other surface of the insulating substrate 20 may be exposed to the other end surface of the magnetic body 50 in the length (L) direction thereof.

However, one end portion of each of the first and second internal coil parts 42 and 44 is not limited to being exposed as described above, and may be exposed to at least one surface of the magnetic body 50.

The first and second external electrodes 81 and 82 may be formed on the outer surfaces of the magnetic body 50 to be connected to the first and second internal coil parts 42 and 44 exposed to the end surfaces of the magnetic body 50, respectively.

The first and second external electrodes 81 and 82 may be formed of a metal having excellent electrical conductivity, such as nickel (Ni), copper (Cu), tin (Sn), silver (Ag), or an alloy thereof.

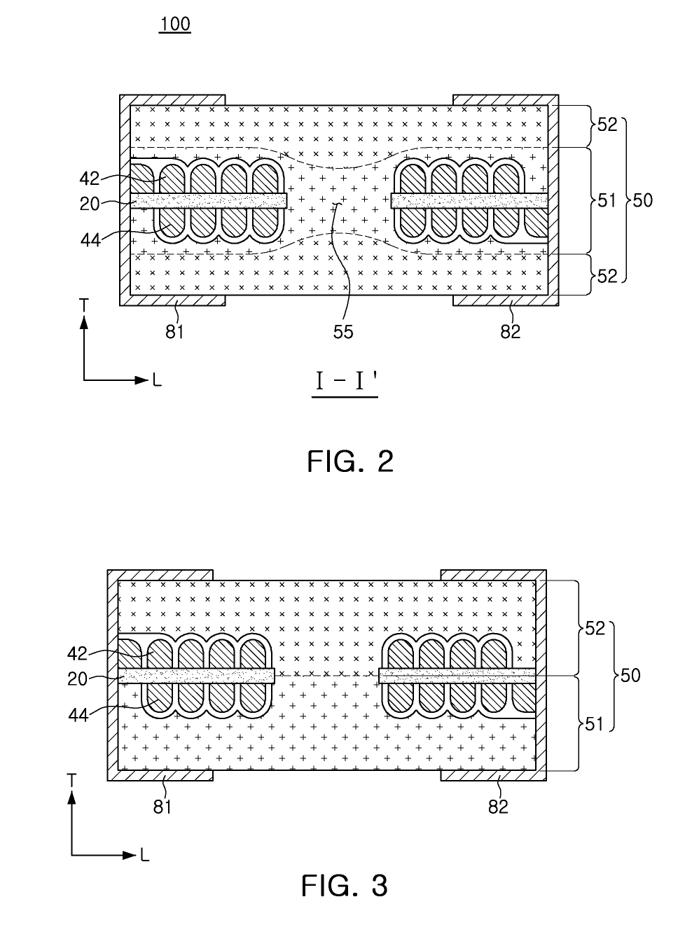

FIG. 2 is a cross-sectional view taken along line I-I′ of FIG. 1.

Referring to FIG. 2, the magnetic body 50, according to an exemplary embodiment, may include a first magnetic part 51 and second magnetic part 52 distinguished from the first magnetic part 51.

Although a boundary between the first and second magnetic parts 51 and 52 adjacent to each other may be observed using a scanning electron microscope (SEM), the first and second magnetic parts 51 and 52 are not necessarily distinguished from each other by the boundary observed by the SEM, and may be distinguished from each other by at least one of differences in kinds, mass-median-diameter, and mixed volume ratios of magnetic metal powders contained in the first and second magnetic parts 51 and 52. The mass-median-diameter can be a calculated particle size distribution D50 value. However, the method for calculating the mass-median-diameter is not limited thereto.

The first and second magnetic parts 51 and 52, according to an exemplary embodiment, may contain different kinds of magnetic metal powder.

For example, the first magnetic part 51 may contain an Fe—Si—Cr based crystalline metal having excellent direct current (DC)-bias characteristics by decreasing eddy current loss, but having general specific resistance and magnetic permeability, and the second magnetic part 52 may contain an Fe—Si—B—Cr based amorphous metal having high magnetic permeability and excellent quality factor (QF).

As described above, the first and second magnetic parts 51 and 52 may be distinguished from each other by containing different kinds of magnetic metal powder. The first and second magnetic parts 51 and 52 may contain different kinds of magnetic metal powder having different characteristics, whereby an electronic component having various characteristics may be implemented.

However, the kinds of magnetic metal powder contained in the first and second magnetic parts 51 and 52 are not necessarily limited to those of the above-mentioned example. That is, the first and second magnetic parts 51 and 52 may contain different kinds of magnetic metal powder having various characteristics.

Magnetic metal powders contained in the first and second magnetic parts 51 and 52, according to another exemplary embodiment may have different mass-median-diameters.

For example, the first magnetic part 51 may contain a magnetic metal powder having a mass-median-diameter value within the range of 18 μm to 22 μm, and the second magnetic part may contain a magnetic metal powder having a mass-median-diameter value within the range of 2 μm to 4 μm.

The kinds of magnetic metal powder contained in the first and second magnetic parts 51 ad 52 and having different mass-median-diameter values maybe the same as or different from each other.

As described above, the first and second magnetic parts 51 and 52 may be distinguished from each other by containing the magnetic metal powder having different mass-median-diameter values.

Magnetic metal powder having a high mass-median-diameter value may implement high magnetic permeability, and magnetic metal powder having a low mass-median-diameter value may exhibit low magnetic permeability, but may be a low loss material. Therefore, the magnetic metal powder having a low mass-median-diameter value may serve to complement core loss that may be increased at the time of using the high magnetic permeability material, and may improve surface roughness and alleviate a plating spreading phenomenon due to coarse powder.

However, the mass-median-diameter of the magnetic metal powder contained in the first and second magnetic parts 51 and 52 is not necessarily limited to that of the above-mentioned example. That is, the first and second magnetic parts 51 and 52 may contain magnetic metal powder having different mass-median-diameter values as long as various characteristics may be implemented.

In another exemplary embodiment, the first and second magnetic part 51 and 52 may contain two or more kinds of magnetic metal powder having different particle sizes and mixed with each other at a predetermined ratio. Here, the mixed volume ratios of the two or more kinds of magnetic metal powder of the first and second magnetic parts 51 and 52 may be different from each other.

As described above, in a case in which the first and second magnetic parts 51 and 52 contain two or more kinds of magnetic metal powder having different particle sizes, the first and second magnetic parts 51 and 52 may be distinguished from each other by adjusting the mixed volume ratios of the magnetic metal powders to be different from each other.

The mass-median-diameters or the mixed volume ratios of the magnetic metal powders contained in the first and second magnetic parts 51 and 52 may be different from each other, whereby the first and second magnetic parts 51 and 52 may have different packing factors.

At least one of the kinds, mass-median-diameters, and mixed volume ratios of the magnetic metal powders may differ in the first and second magnetic parts 51 and 52, according to an exemplary embodiment, and thus the magnetic metal powders may have different packing factors, and magnetic permeability, QF, and DC-bias characteristics may be improved.

The first and second magnetic parts 51 and 52 may be disposed in upper and lower portions of the magnetic body 50, respectively.

Each of the first and second magnetic parts 51 and 52 may be formed by stacking magnetic sheets. At least one of the kinds, mass-median-diameters, and mixed volume ratios of magnetic metal powders contained in different magnetic sheets forming the first and second magnetic parts 51 and 52 may be different from each other.

Therefore, since the first and second magnetic parts 51 and 52 are formed by stacking the magnetic sheets, they may be disposed in upper and lower positions of the magnetic body 50, respectively.

As illustrated in FIG. 2, in the magnetic body 50, according to an exemplary embodiment in the present disclosure, the first magnetic part 51 may be formed in a core part in which the internal coil parts 42 and 44 are positioned, and the second magnetic part 52 may be formed on upper and lower surfaces of the first magnetic part 51.

In the formation of the first and second magnetic parts 51 and 52 by stacking, compressing, and hardening the magnetic sheets, the first magnetic part 51 in a region of the core part 55 may have a concave shape.

FIGS. 3 through 5 are cross-sectional views of electronic components according to other exemplary embodiments in an LT direction.

Referring to FIG. 3, in a magnetic body 50, according to another exemplary embodiment, the first magnetic part 51 may be formed in a lower portion of the magnetic body 50, and the second magnetic part 52 may be formed in an upper portion of the magnetic body 50.

However, positions of the first and second magnetic parts 51 and 52 are not limited thereto. That is, the first magnetic part 51 may be formed in the upper portion of the magnetic body 50 and the second magnetic part 52 may be formed in the lower portion of the magnetic body 50, and a thickness ratio between the first and second magnetic parts 51 and 52 is not particularly limited. In addition, the magnetic body 50 may further include another magnetic part distinguished from the first and second magnetic parts 51 and 52.

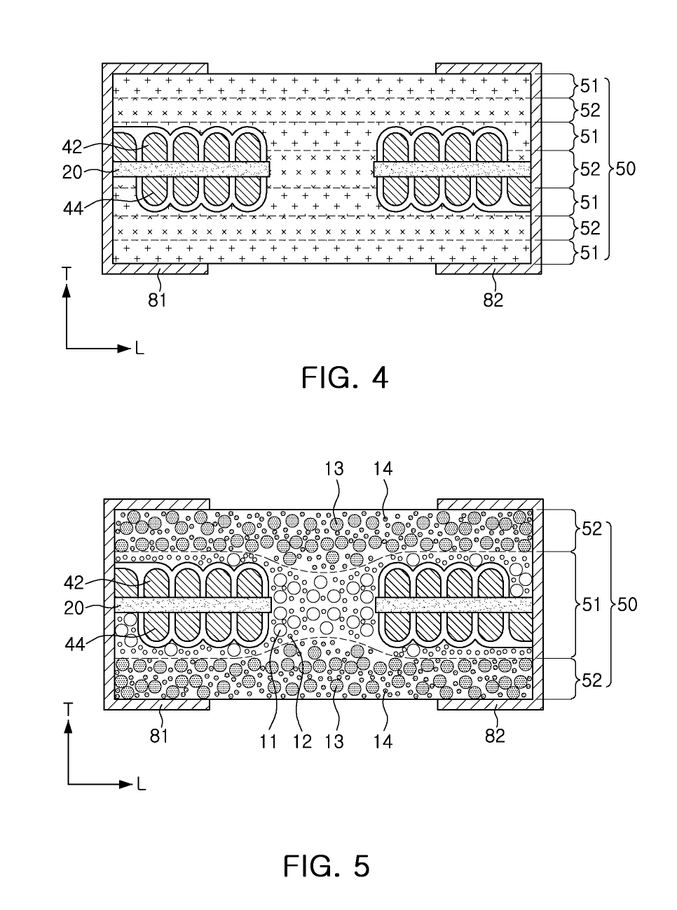

Referring to FIG. 4, in a magnetic body 50, according to another exemplary embodiment, the first and second magnetic parts 51 and 52 may be alternatively stacked.

The first and second magnetic parts 51 and 52 may be alternatively stacked a plurality of times, and a thickness ratio between the first and second magnetic parts 51 and 52 alternately stacked, the number of alternations of the first and second magnetic parts 51 and 52, and the like, are not particularly limited, and may be variously adjusted depending on characteristics that are to be implemented.

FIG. 5 is a view illustrating a case in which the first and second magnetic parts 51 and 52, according to another exemplary embodiment, contain two kinds of magnetic metal powder having different particle sizes and mixed with each other at a predetermined ratio.

Referring to FIG. 5, the first magnetic part 51 may contain a first magnetic metal powder 11 and a second magnetic metal powder 12 having a mass-median-diameter less than that of the first magnetic metal powder 11.

The first magnetic metal powder 11 having a high mass-median-diameter value may implement high magnetic permeability, and the first magnetic metal powder 11 having a high mass-median-diameter value and the second magnetic metal powder 12 having a low mass-median-diameter value may be mixed with each other, and thus a packing factor of the magnetic metal powder is increased, whereby magnetic permeability may be further improved and a QF value may be improved.

The mass-median-diameter value of the first magnetic metal powder 11 may be within the range of 15 μm to 60 μm, and the mass-median-diameter value of the second magnetic metal powder 12 may be within the range of 0.1 μm to 8 μm.

The mass-median-diameter value may be a D50 value measured using a particle diameter and particle size distribution measuring apparatus through a laser diffraction scattering method.

The first and second magnetic metal powders 11 and 12 may be mixed with each other at a volume ratio of 3:7 to 8.5:1.5. Since the first and second magnetic metal powders 11 and 12 are mixed with each other at the above-mentioned volume ratio, a packing factor of the magnetic metal powder may be improved, and thus magnetic permeability may be further improved and a QF value may be improved.

The second magnetic part 52 may contain a third magnetic metal powder 13 and a fourth magnetic metal powder 14 having a mass-median-diameter less than that of the third magnetic metal powder 13.

A kind or mass-median-diameter of at least one of the third and fourth magnetic metal powders 13 and 14 contained in the second magnetic part 52 may be different from that of the first and second magnetic metal powders 11 and 12 contained in the first magnetic part 51.

Alternatively, a kind or mass-median-diameter of at least one of the third and fourth magnetic metal powders 13 and 14 contained in the second magnetic part 52 may be the same as that of the first and second magnetic metal powders 11 and 12 contained in the first magnetic part 51, and a mixed volume ratio of at least one of the third and fourth magnetic metal powders 13 and 14 may be different from that of the first and second magnetic metal powders 11 and 12.

As described above, the electronic component 100, according to an exemplary embodiment, may include the magnetic body 50 including the first and second magnetic parts 51 and 52 distinguished from each other by at least one of differences in the kinds, mass-median-diameters, and mixed volume ratios of the magnetic metal powders, whereby excellent magnetic permeability, QF, and DC-bias characteristics may be implemented.

### Method for Manufacturing Electronic Component

In a method for manufacturing an electronic component according to an exemplary embodiment, first and second magnetic sheets containing magnetic metal powder may first be prepared.

The first and second magnetic sheets maybe manufactured by mixing magnetic metal powder and organic materials such as a binder, a solvent, and the like, with each other to prepare slurry, applying the slurry at a thickness of tens of micrometers on carrier films by a doctor blade method, and then drying the same.

Here, the first and second magnetic sheets may be formed by differing at least one of the kinds, mass-median-diameters, and mixed volume ratios of magnetic metal powders contained therein.

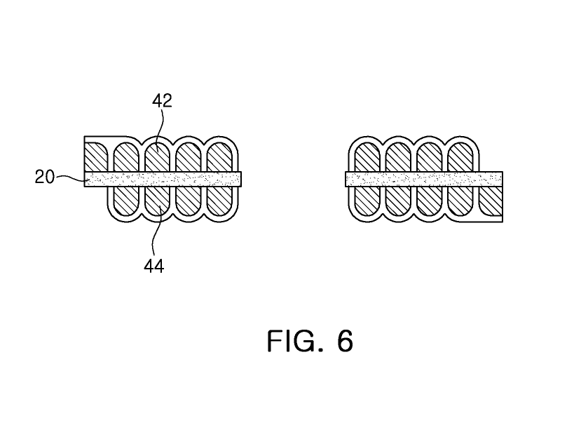

FIG. 6 is a view of the formation of the internal coil parts of the electronic component according to an exemplary embodiment.

Referring to FIG. 6, the internal coil parts 42 and 44 may first be formed on one surface and the other surface of the insulating substrate 20, respectively.

A method of forming the internal coil parts 42 and 44 may be, for example, an electroplating method, but is not limited thereto. The internal coil parts 42 and 44 may be formed of a metal having excellent electrical conductivity, such as silver (Ag), palladium (Pd), aluminum (Al), nickel (Ni), titanium (Ti), gold (Au), copper (Cu), platinum (Pt), or an alloy thereof.

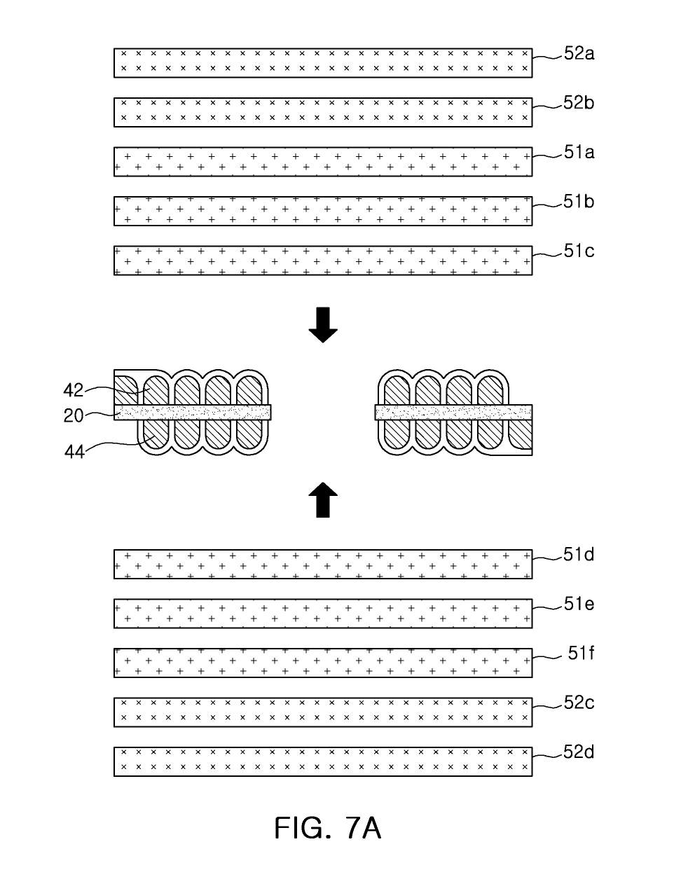

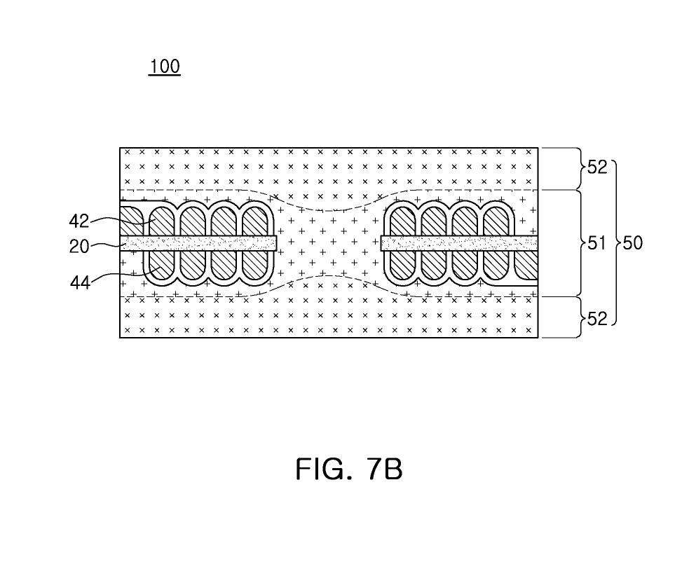

FIGS. 7A and 7B are views of the formation of a magnetic body of the electronic component according to an exemplary embodiment.

Referring to FIG. 7A, first magnetic sheets 51a to 51c and 51d to 51f may be stacked on upper and lower surfaces of the internal coil parts 42 and 44, respectively, to form a core part, and the second magnetic sheets 52a and 52b and 52c and 52d may be stacked on upper and lower surfaces of the core part, respectively, to form cover parts.

Referring to FIG. 7B, in the magnetic body 50, according to an exemplary embodiment formed as described above, the first magnetic part 51 may be formed in the core part in which the internal coil parts 42 and 44 are positioned, and the second magnetic part 52 may be formed on the upper and lower surfaces of the first magnetic part 51.

In the formation of the first and second magnetic parts 51 and 52 by stacking, compressing, and hardening the magnetic sheets, the first magnetic part 51 in a region of the core part 55 may have a concave shape.

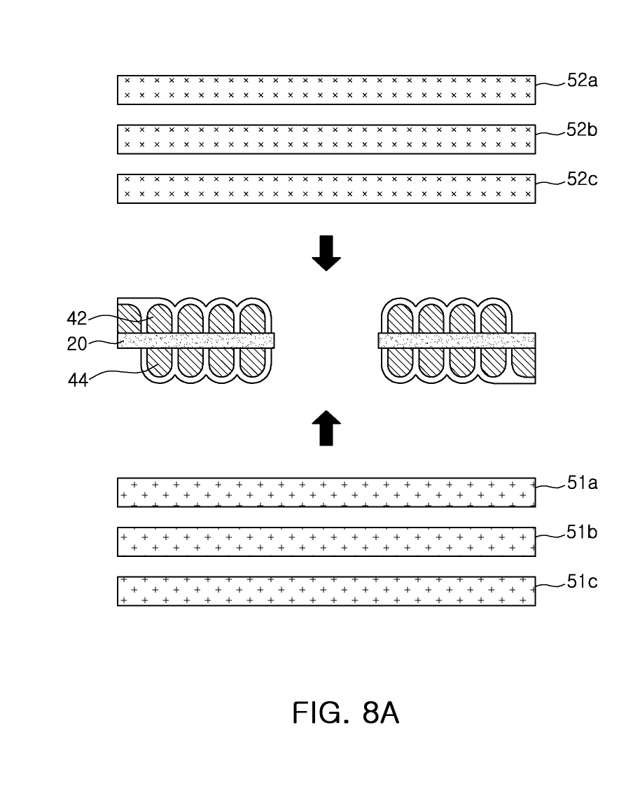

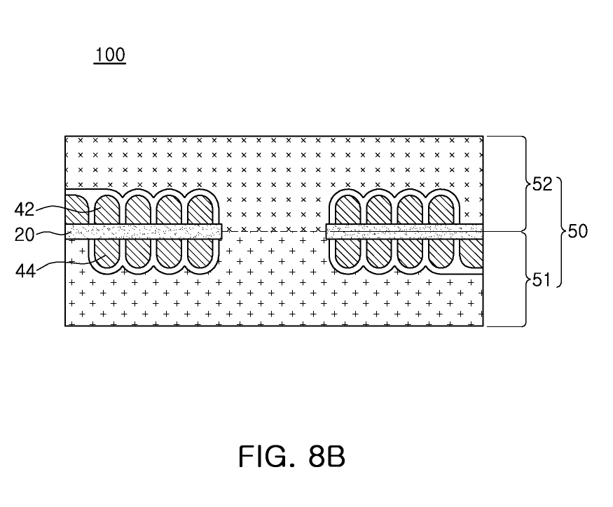

FIGS. 8A and 8B are views of the formation of a magnetic body of the electronic component according to another exemplary embodiment.

Referring to FIG. 8A, the first magnetic sheets 51a to 51c may be stacked on the lower surfaces of the internal coil parts 42 and 44, and the second magnetic sheets 52a to 52c may be stacked on the upper surfaces of the internal coil parts 42 and 44 to form the magnetic body 50.

Referring to FIG. 8B, in the magnetic body 50, according to another exemplary embodiment formed as described above, the first magnetic part 51 may be formed in the lower portion of the magnetic body 50, and the second magnetic part 52 may be formed in the upper portion of the magnetic body 50.

However, the first magnetic sheets 51a to 51c and the second magnetic sheets 52a to 52c are not necessarily limited to being stacked as described above. That is, the first magnetic sheets 51a to 51c may be stacked on the upper surfaces of the internal coil parts 42 and 44, and the second magnetic sheets 52a to 52c may be stacked on the lower surfaces of the internal coil parts 42 and 44.

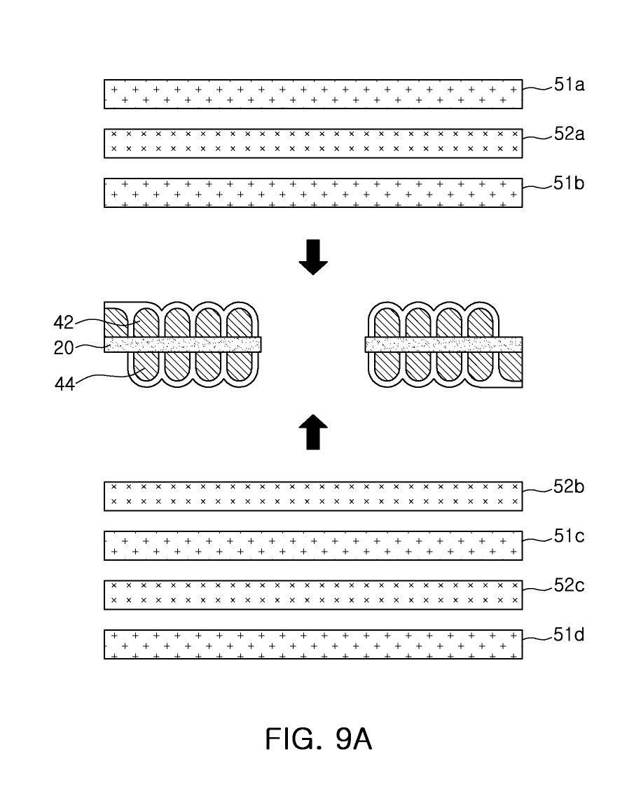

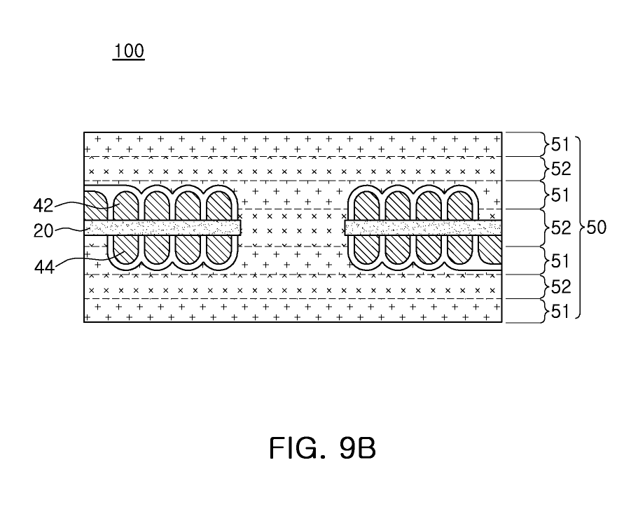

FIGS. 9A and 9B are views of the formation of a magnetic body of the electronic component according to another exemplary embodiment.

Referring to FIG. 9A, the first magnetic sheets 51a to 51c and the second magnetic sheets 52a to 52c may be alternately stacked on the upper and lower surfaces of the internal coil parts 42 and 44 to form the magnetic body 50.

Referring to FIG. 9B, in the magnetic body 50, according to another exemplary embodiment formed as described above, the first and second magnetic parts 51 and 52 may be alternatively stacked.

However, a thickness ratio between the first and second magnetic parts 51 and 52 alternately stacked, the number of alternations of the first and second magnetic parts 51 and 52, and the like, are not particularly limited, and may be variously adjusted depending on characteristics that are to be implemented.

The magnetic body 50 may be formed by stacking the first and second magnetic sheets, compressing the stacked first and second magnetic sheets by a laminate method or an isostatic press method, and hardening the compressed first and second magnetic sheets.

The first and second magnetic sheets illustrated in FIGS. 7A, 8A, and 9A may be examples of the stack of magnetic sheets, and the thicknesses and the number of stacked magnetic sheets are not limited thereto.

The first and second magnetic sheets may be formed by differing at least one of the kinds, mass-median-diameters, and mixed volume ratios of the magnetic metal powders contained therein.

Particularly, the mass-median-diameters and the mixed volume ratios of the magnetic metal powders contained in the first and second magnetic sheets may be different from each other, and thus the first and second magnetic sheets may have different packing factors.

The first magnetic sheet, according to an exemplary embodiment, may contain the first magnetic metal powder 11 and the second magnetic metal powder 12 having a mass-median-diameter less than that of the first magnetic metal powder 11.

The mass-median-diameter value of the first magnetic metal powder 11 may be within the range of 15 μm to 60 μm, and the mass-median-diameter value of the second magnetic metal powder 12 may be within the range of 0.1 μm to 8 μm.

The first and second magnetic metal powders 11 and 12 may be mixed with each other at a volume ratio of 3:7 to 8.5:1.5.

In addition, the second magnetic sheet, according to an exemplary embodiment, may contain the third magnetic metal powder 13 and the fourth magnetic metal powder 14 having a mass-median-diameter less than that of the third magnetic metal powder 13.

A kind or mass-median-diameter of at least one of the third and fourth magnetic metal powders 13 and 14 contained in the second magnetic sheet may be different from that of the first and second magnetic metal powders 11 and 12 contained in the first magnetic sheet.

Alternatively, a kind or mass-median-diameter of at least one of the third and fourth magnetic metal powders 13 and 14 contained in the second magnetic sheet may be the same as that of the first and second magnetic metal powders 11 and 12 contained in the first magnetic sheet, and a mixed volume ratio of at least one of the third and fourth magnetic metal powders 13 and 14 may be different from that of the first and second magnetic metal powders 11 and 12.

As set forth above, according to exemplary embodiments, excellent QF and DC-bias characteristics (change characteristics in inductance depending on application of current) may be implemented.

While exemplary embodiments have been shown and described above, it will be apparent to those skilled in the art that modifications and variations could be made without departing from the scope of the present invention as defined by the appended claims.

What is claimed is:

1. An electronic component comprising:
a magnetic body containing magnetic metal powder; and
internal coil parts embedded in the magnetic body,
wherein the magnetic body includes a first magnetic part and a second magnetic part distinguished from the first magnetic part.

2. The electronic component of claim 1, wherein the first and second magnetic parts contain different kinds of magnetic metal powder.

3. The electronic component of claim 1, wherein the first magnetic part contains a first magnetic metal powder and a second magnetic metal powder, and
a mass-median-diameter of the second magnetic metal powder is less than that of the first magnetic metal powder.

4. The electronic component of claim 3, wherein the mass-median-diameter of the first magnetic metal powder is within the range of 15 μm to 60 μm, and
the mass-median-diameter of the second magnetic metal powder is within the range of 0.1 μm to 8 μm.

5. The electronic component of claim 3, wherein the first and second magnetic metal powders are mixed with each other at a volume ratio of 3:7 to 8.5:1.5.

6. The electronic component of claim 3, wherein the second magnetic part contains a third magnetic metal powder and a fourth magnetic metal powder, and
a mass-median-diameter of the fourth magnetic metal powder is less than that of the third magnetic metal powder.

7. The electronic component of claim 6, wherein at least one of a kind and the mass-median-diameter of at least one of the third and fourth magnetic metal powders is different from that of the first and second magnetic metal powders.

8. The electronic component of claim 6, wherein a mixed volume ratio of the magnetic metal powders contained in the second magnetic part is different from that of the magnetic metal powders contained in the first magnetic part.

9. A method for manufacturing an electronic component, the method comprising:
preparing first and second magnetic sheets containing magnetic metal powder; and
stacking the first and second magnetic sheets on upper and lower surfaces of internal coil parts to form a magnetic body,
wherein at least one of kinds, mass-median-diameters, and mixed volume ratios of the magnetic metal powder differs in the first and second magnetic sheets.

10. The method of claim 9, wherein the first magnetic sheets are stacked on the upper and lower surfaces of the internal coil parts to form a core part, and
the second magnetic sheets are stacked on upper and lower surfaces of the core part to form a cover part.

11. The method of claim 9, wherein one of the first and second magnetic sheets are stacked to form a lower portion of the magnetic body, and
the other of the first and second magnetic sheets are stacked to form an upper portion of the magnetic body.

12. The method of claim 9, wherein the first and second magnetic sheets have different packing factors.

13. The method of claim 9, wherein the first magnetic sheets contain a first magnetic metal powder and a second magnetic metal powder, and
a mass-median-diameter of the second magnetic metal powder is less than that of the first magnetic metal powder.

14. The method of claim 13, wherein the mass-median-diameter of the first magnetic metal powder is within the range of 15 μm to 60 μm, and
the mass-median-diameter of the second magnetic metal powder is within the range of 0.1 μm to 8 μm.

15. The method of claim 13, wherein the first and second magnetic metal powders are mixed with each other at a volume ratio of 3:7 to 8.5:1.5.

16. The method of claim 13, wherein the second magnetic sheet contains a third magnetic metal powder and a fourth magnetic metal powder, and
a mass-median-diameter of the fourth magnetic metal powder is less than that of the third magnetic metal powder.
